(19) United States
(12) Patent Application Publication
(10) Pub. No.: US 2009/0244378 A1
(43) Pub. Date: Oct. 1, 2009

(54) Record and replay television device and method

(76) Inventor: Wanhua Chen, San Marcos, CA (US)

Correspondence Address: MILLER PATENT SERVICES, 2500 DOCKERY LANE, RALEIGH, NC, 27606, US

(21) Appl. No.: 12/079,542

(22) Filed: Mar. 27, 2008

(51) Int. Cl. H04N 5/45; H04N 5/44

(52) U.S. Cl. 348/565; 348/734; 348/E05.096; 348/E05.112

(57) ABSTRACT

In certain embodiments, a method of controlling operation of a television receiver device involves determining that there remote control commands for “record” and “play” are directed to the television receiver device; checking a remote control receiver for receipt of either “record” or “play” command; when a record command is received by the remote control receiver, storing N seconds of scaled video to a memory residing in the television receiver device; and when a play command is received by the remote control receiver, playing out the N seconds of scaled video from the memory in a picture-in-picture (PIP) window. This abstract is not to be considered limiting, since other embodiments may deviate from the features described in this abstract.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Video tape recorders (VTRs) and digital video recorders (DVRs) are popular consumer electronics devices used to record and play back content received by a television receiver device. These devices, while popular, may not be within everyone's budget, and due to the time constraints in setup of such devices, it may not be practical for use when one wishes to capture a small segment of video for use, for example, in an instant replay environment. This may be particularly the case when the scene that one desires to capture approaches unexpectedly. It may also be desirable to capture a small segment of video content from any source including video tape recorders and digital video recorders without need to stop and rewind.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a block diagram depicting a television receiver and remote control unit consistent with certain embodiments of the present invention.

FIG. 2 is a block diagram of a television receiver consistent with certain embodiments of the present invention.

FIG. 3 is a flow chart depicting operation consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

The term “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. The term may also be interpreted to encompass commercial spots and other program-like content which may not be reported as a program in an electronic program guide.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with certain embodiments consistent with the present invention, it is noted that at least two buttons used in a typical television or home entertainment system remote control are generally designated for use in connection with a VCR (video cassette recorder), DVD (digital versatile disc) player or DVR (digital video recorder, also known as a PVR or personal video recorder). One such button is record and one button is play (but there may be others). In accord with certain embodiments, these buttons can be shared between the television and the VCR or other recorder/player devices. For example, when a VCR or DVD player is on and connected to the TV, these two buttons are used as normal VCR and DVR features. But, when a VCR or DVD or DVR device is not on or connected, these two buttons can be used for integrated TV features. In accord with certain embodiments, when these buttons are used as TV features, pressing the “Record” button, will record a few seconds of TV video. Pressing the “Play” button will play back this few seconds (e.g., 5-10 seconds or so) of video in a picture-in-picture (PIP) mode at a slower playback speed (e.g., half speed or quarter speed). This feature can be used, for example, to view sports play scenes or other events slowly. The PIP image is shown in a window that is smaller, but forms a part of the television's video display. Generally, a PIP image will occupy a relatively small portion of the display so that the main image can be near fully understood and appreciated when the PIP image is active (e.g., less than about one fourth and preferably about one eighth of the main display area).

In accord with certain embodiments, this invention can be used to record and review certain part of TV video even there is no DVR or VCR connected. The feature can be implemented at minimal cost since the amount of record time need not be great and the video can be compressed or scaled to the smaller image to fit a picture-in-picture window.

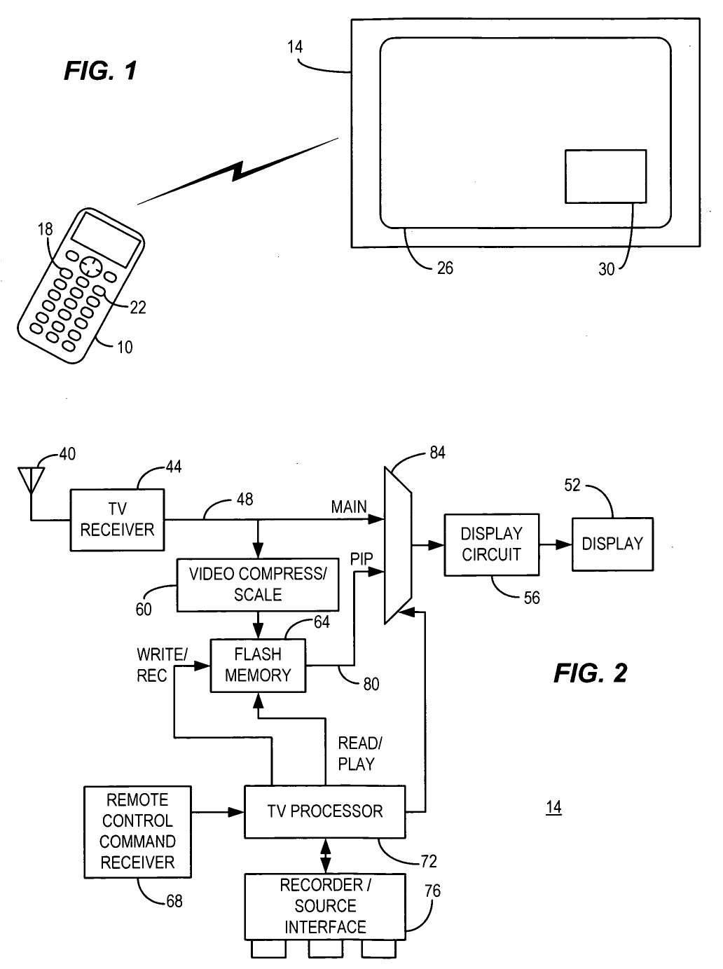

Turning now to FIG. 1, a remote controller or remote commander 10 is depicted which is capable of controlling not only a television 14, but also other devices having record and/or play functions (not shown). The control of these functions is carried out using a record button 18 and a play button 22 respectively. In the television device 14 depicted, a main image viewing area 26 is shown as is a picture-in-picture viewing area 30. In certain embodiments consistent with the present invention, the record and play buttons are also used to control recording and playback functions incorporated into the television device 14 in the manner to be described below.

As will be appreciated by those skilled in the art, when remote controls are used for control of multiple devices, they usually incorporate buttons or other controls which are used to switch between the various controlled devices. Hence the operational mode of the remote control can be for control of a TV, DVR, VCR or other device. In accord with certain embodiments consistent with the present invention, the remote control can be configured to control a television using record and play functions by any mechanism for setting a control mode for the remote control such that it controls operation of the television. In one example, a “TV” button or switch can be actuated prior to issuing TV commands. Other mechanisms are also contemplated.

With reference to FIG. 2, television device 14 is depicted in greater detail wherein an input signal is shown to be received at an antenna 40 (or other content source such as cable or satellite services via a set top box, set back box or directly, for example). The input signal is tuned, received, demodulated and decoded (and possibly decrypted) at the TV receiver block 44, which represents the receiver front end, to produce digital data packets representing video content at an output 48. This output is generally used to produce the main image displayed on the display 52 using display driving circuits 56.

In certain embodiments consistent with the present invention, the video signal at 48 can be compressed or scaled at 60 to the size of a PIP image and stored in a memory, e.g., a flash memory or other non-volatile or volatile memory device 64. The memory device 64 need only be large enough to store a few seconds (e.g., 5-10 seconds or so) of scaled and/or compressed video suitable for display in a PIP window. Such recording is initiated when a command from a remote commander 10 is received at a remote control command receiver 68. Record and Play commands, when received are processed by the TV processor 72, which can be realized as a programmed processor having CPU and associated components or any other suitable realization for control of overall operation of the television. The detailed operation of all aspects of the TV processor 72 is not depicted in this drawing for clarity. TV processor 72 is coupled to input source interfaces 76 for recorders and playback devices such as DVRs and the like (collectively referred to as recording devices) and the like such as HDMI (High Definition Multimedia Interface) interfaces. Hence, the TV processor is able to know whether such devices are present or absent, either by direct detection of active devices or by user programming and storage of the presence and nature of such devices in a configuration table that can be accessed by TV processor 72.

In the event no recorder or source device is present which can utilize record and play commands, the TV processor knows to use the record and play commands internally within the TV receiver device 14. In other embodiments, the remote controller can be programmed to designate the record or play command as being for the TV rather than a connected device when desired, even in the presence of a recording device.

When a record command is received which is deemed by the TV processor to be designated for the TV and not an external device, the incoming video stream at 48 is compressed or scaled to the size of a PIP window at the compress/scale block 60, and the compressed and/or scaled video is stored to memory 64. For purposes of this document, the term “scale” is used to interchangeably mean compressing, scaling or a combination thereof using any suitable data size reduction technique.

After a record command is received, the scaled video is recorded to the memory 64 continuously until the memory is full. This is contemplated to be approximately 5-10 seconds (N seconds in general) or so of scaled video, hence, implementation of this function will not consume large amounts of memory thereby driving up cost. Variations will be apparent to those skilled in the art upon consideration of these teachings. For example, recording can be stopped upon a second press of the record button, but recalling that only about 5-10 seconds of video are recorded, a stop function may be unnecessary. Or, alternatively, the recording can continue in a cache-like manner wherein recording proceeds indefinitely until stopped (e.g., by a stop command, another record command or a play command) so that only the last N seconds remain stored in the cache-like memory.

When the play command is issued, a PIP window is opened by TV processor 72 and slow motion (e.g., half speed or quarter speed) playback of the N seconds of video is carried out in the PIP window via a PIP input 80 of which is multiplexed or otherwise combined at 84 with the main image (or overlaid thereupon). Once played, the window can close for normal viewing. Repeated pressing of the play button thereby results in reopening the window for playback repeatedly of the most recently recorded video, in one embodiment. In other embodiments, the playback can be stopped by pressing the record button to start a new recording sequence, pressing a stop button or pressing a PIP button to close the window. In still other embodiments, the recorded video can repeatedly play until the user manually stops the play (e.g., by closing the PIP window or other suitable command). Other embodiments will occur to those skilled in the art upon consideration of the present teachings.

It is further noted that the features provided in accordance with certain embodiments of the present invention can be used without regard for the source of the video content. Thus, it can be used for the convenience of the user in capturing a small segment video content from any source. The source could not only include satellite, IP, broadcast or cable sources, but can also be from VTRs and DVRs, and any other program source without need to stop and rewind, as long the remote control is in a mode for control of the TV.

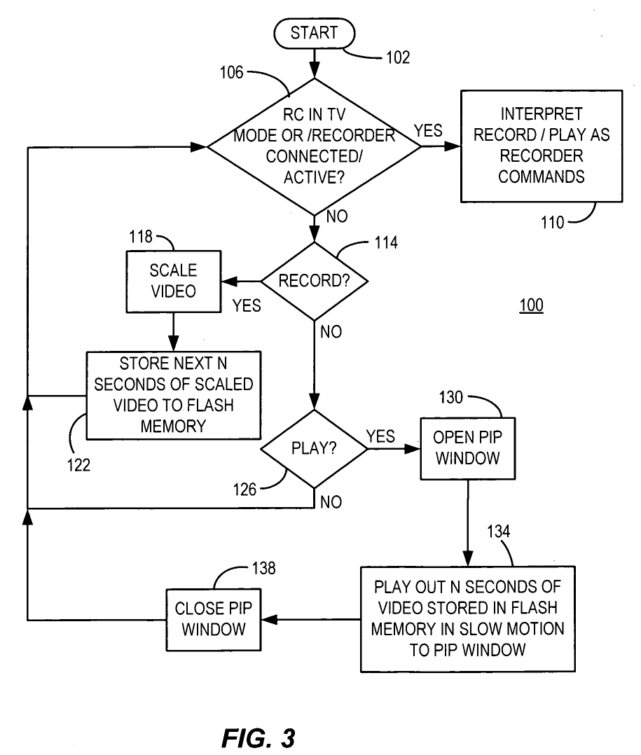

One process for operation of a television set according to embodiments consistent with the present invention is depicted in the flow chart 100 of FIG. 3 starting at 102. At 106 the TV processor determines that a play or record command is directed at the television receiver device. This can be accomplished, for example, by configuring the remote control for control of the television rather than a connected source (i.e., the TV knows by receipt of a specific command from the remote that is destined for the TV). Alternatively, at 106, the TV processor determines (e.g., by checking the state of a table containing user entries or automated entries, or by checking the status of inputs or activity state of inputs) whether or not a player/recorder type device is connected to the television set at interface 76. In either event, the point is that the television processor understands that the commands that follow are directed toward the television set and not a connected recording or playback device.

If so, the television ignores record and play type commands at 110 since such commands are destined for other devices. However, if such devices are not connected, or the TV processor 72 is otherwise able to determine that playback is intended for the TV 14 (e.g., connected devices are off or the remote commander designates that the record or play commands are destined for the TV) then control passes to 114 where if a record command has been issued, the video is scaled for the PIP window at 118 and the next N seconds of video is stored to flash or other designated memory at 122. Control then returns to 106 when all N seconds have been recorded.

If a record command is not received at 114 but a play command is received at 126, a PIP window is opened at 130 and the N seconds of stored scaled video is played out in the PIP window at 134. In this embodiment, once the N seconds of stored scaled video is played out in PIP window at 134, the PIP window is closed at 138 and the process returns to 106. As noted above, many variations in this process, including but not limited to those discussed herein, are possible without departing from embodiments consistent with the present invention, and the illustrated process 100 is merely one such embodiment.

Thus, a television receiver device consistent with certain embodiments has a television receiver receiving a television signal and producing a digital video output therefrom. A video display displays video images. A video scaling device scales the digital video output to a scaled size suitable for display in a picture-in-picture (PIP) display window of the display. A memory is coupled to the video scaling device for receiving and storing the scaled digital video from the video scaling device, the memory being of such size to store N seconds of scaled video. A remote command receiver receives commands from a remote commander. An interface is provided for connection of at least one video recording device. A processor receives “record” and “play” commands from the remote command receiver which are directed at the television receiver device, wherein: upon receipt of a record command, the processor enables recording of the scaled video from the video scaling device to the memory; and upon receipt of a playback command, the processor enables playback of the N seconds of scaled video from the memory to the PIP window on the display.

In certain embodiments, upon receipt of the play command, the processor enables playback of the scaled video from the memory by opening the PIP window and causing the N seconds of scaled video to be multiplexed or overlaid on a main video signal. In certain embodiments, the processor closes the PIP window after the playback of the N seconds of scaled video from the memory to the PIP window on the display. In certain embodiments, the processor closes the PIP window after the playback of the N seconds of scaled video from the memory to the PIP window on the display. In certain embodiments, N seconds is approximately equal to 5 to 10 seconds. In certain embodiments, the processor determines that commands are directed to the television receiver device by virtue of their being no active video recording device is connected to the interface by reading the information from a stored table. In certain embodiments, the processor determines that commands are directed to the television receiver device by virtue of their being no active video recording device is connected to the interface by inspection of connections to the interface. In certain embodiments, the processor determines that commands are directed to the television receiver device by virtue of a configuration of the remote commander being configured to transmit the commands in a television mode. In certain embodiments, the processor determines that no active video recording device is connected to the interface by inspecting a status of devices connected to the interface. In certain embodiments, the memory comprises flash memory In certain embodiments, the PIP window occupies less than about one fourth of the display. In certain embodiments, upon receipt of a record command, the processor enables continuous recording of the latest N seconds of the scaled video from the video scaling device to the memory until the recording is halted by a remote command. In certain embodiments, the playback is carried out in slow motion.

In another television receiver device consistent with certain embodiments, a television receiver receives a television signal and produces a digital video output therefrom. A video display displays video images. A video scaling device scales the digital video output to a scaled size suitable for display in a picture-in-picture (PIP) display window of the display. A memory is coupled to the video scaling device for receiving and storing the scaled digital video from the video scaling device, the memory being of such size to store N seconds of scaled video, where N is approximately 5-10. A remote command receiver receives commands from a remote commander. An interface can be provided for connection of at least one video recording device. A processor determines that receives “record” and “play” commands from the remote command receiver directed to the television receiver device, wherein: upon receipt of a record command, the processor enables recording of the scaled video from the video scaling device to the memory; upon receipt of a playback command, the processor enables slow motion playback of the N seconds of scaled video from the memory to the PIP window on the display. Upon receipt of the play command, the processor enables playback of the scaled video from the memory by opening the PIP window and causing the N seconds of scaled video to be multiplexed or overlaid on a main video signal. The processor closes the PIP window after the playback of the N seconds of scaled video from the memory to the PIP window on the display.

In certain embodiments, the processor determines that commands are directed to the television receiver device by virtue of a configuration of the remote commander being configured to transmit the commands in a television mode. In certain embodiments, the processor determines that commands are directed to the television receiver device by determining that no active video recording device is connected to the interface by reading the information from a stored table. In certain embodiments, the processor determines that commands are directed to the television receiver device by virtue of their being no active video recording device is connected to the interface by inspection of connections to the interface for an active connected video recording device. In certain embodiments, upon receipt of a record command, the processor enables continuous recording of the latest N seconds of the scaled video from the video scaling device to the memory until the recording is halted by a remote command.

In certain embodiments, a method of controlling operation of a television receiver device, involves determining that there remote control commands for “record” and “play” are directed to the television receiver device; checking a remote control receiver for receipt of either “record” or “play” command; when a record command is received by the remote control receiver, storing N seconds of scaled video to a memory residing in the television receiver device; and when a play command is received by the remote control receiver, playing out the N seconds of scaled video from the memory in a picture-in-picture (PIP) window.

In certain embodiments, upon receipt of the play command playing back the scaled video from the memory by opening the PIP window and causing the N seconds of scaled video to be multiplexed or overlaid on a main video signal In certain embodiments, the method further involves closing the PIP window after the playback of the N seconds of scaled video from the memory to the PIP window on the display. In certain embodiments, N seconds is approximately equal to 5 to 10 seconds. In certain embodiments, the playback is carried out in slow motion. A computer readable storage medium can store instructions which, when executed on one or more programmed processors, can carry out a methods as described above.

Those skilled in the art will recognize, upon consideration of the above teachings, that certain of the above exemplary embodiments are based upon use of a programmed processor. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments. While certain embodiments herein were described in conjunction with specific circuitry that carries out the functions described, other embodiments are contemplated in which the circuit functions are carried out using equivalent executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware and/or dedicated processors.

While certain illustrative embodiments have been described, it is evident that many alternatives, modifications, permutations and variations will become apparent to those skilled in the art in light of the foregoing description.

What is claimed is:

1. A television receiver device, comprising in combination:
a television receiver receiving a television signal and producing a digital video output therefrom;
a video display for displaying video images;
a video scaling device that scales the digital video output to a scaled size suitable for display in a picture-in-picture (PIP) display window of the display;
a memory coupled to the video scaling device for receiving and storing the scaled digital video from the video scaling device, the memory being of such size to store N seconds of scaled video;
a remote command receiver that receives commands from a remote commander;
an interface for connection of at least one video recording device;
a processor that receives “record” and “play” commands from the remote command receiver which are directed at the television receiver device, wherein:
upon receipt of a record command, the processor enables recording of the scaled video from the video scaling device to the memory; and
upon receipt of a playback command, the processor enables playback of the N seconds of scaled video from the memory to the PIP window on the display.

2. The device according to claim 1, wherein upon receipt of the play command, the processor enables playback of the scaled video from the memory by opening the PIP window and causing the N seconds of scaled video to be multiplexed or overlaid on a main video signal.

3. The device according to claim 2, wherein the processor closes the PIP window after the playback of the N seconds of scaled video from the memory to the PIP window on the display.

4. The device according to claim 1, wherein the processor closes the PIP window after the playback of the N seconds of scaled video from the memory to the PIP window on the display.

5. The device according to claim 1, wherein N seconds is approximately equal to 5 to 10 seconds.

6. The device according to claim 1, wherein the processor determines that commands are directed to the television receiver device by virtue of their being no active video recording device is connected to the interface by reading the information from a stored table.

7. The device according to claim 1, wherein the processor determines that commands are directed to the television receiver device by virtue of their being no active video recording device is connected to the interface by inspection of connections to the interface.

8. The device according to claim 1, wherein the processor determines that commands are directed to the television receiver device by virtue of a configuration of the remote commander being configured to transmit the commands in a television mode.

9. The device according to claim 1, wherein the processor determines that no active video recording device is connected to the interface by inspecting a status of devices connected to the interface.

10. The device according to claim 1, wherein the memory comprises flash memory.

11. The device according to claim 1, wherein the PIP window occupies less than about one fourth of the display.

12. The device according to claim 1, wherein upon receipt of a record command, the processor enables continuous recording of the latest N seconds of the scaled video from the video scaling device to the memory until the recording is halted by a remote command.

13. The device according to claim 1, wherein the playback is carried out in slow motion.

14. A television receiver device, comprising:
a television receiver receiving a television signal and producing a digital video output therefrom;
a video display for displaying video images;
a video scaling device that scales the digital video output to a scaled size suitable for display in a picture-in-picture (PIP) display window of the display;
a memory coupled to the video scaling device for receiving and storing the scaled digital video from the video scaling device, the memory being of such size to store N seconds of scaled video, where N is approximately 5-10;
a remote command receiver that receives commands from a remote commander;
an interface for connection of at least one video recording device;
a processor that determines that receives “record” and “play” commands from the remote command receiver directed to the television receiver device, wherein:
upon receipt of a record command, the processor enables recording of the scaled video from the video scaling device to the memory;
upon receipt of a playback command, the processor enables slow motion playback of the N seconds of scaled video from the memory to the PIP window on the display;
wherein upon receipt of the play command, the processor enables playback of the scaled video from the memory by opening the PIP window and causing the N seconds of scaled video to be multiplexed or overlaid on a main video signal; and
wherein the processor closes the PIP window after the playback of the N seconds of scaled video from the memory to the PIP window on the display.

15. The device according to claim 14, wherein the processor determines that commands are directed to the television receiver device by virtue of a configuration of the remote commander being configured to transmit the commands in a television mode.

16. The device according to claim 14, wherein the processor determines that commands are directed to the television receiver device by determining that no active video recording device is connected to the interface by reading the information from a stored table.

17. The device according to claim 16, wherein the processor determines that commands are directed to the television receiver device by virtue of their being no active video recording device is connected to the interface by inspection of connections to the interface for an active connected video recording device.

18. The device according to claim 14, wherein upon receipt of a record command, the processor enables continuous recording of the latest N seconds of the scaled video from the video scaling device to the memory until the recording is halted by a remote command.

19. A method of controlling operation of a television receiver device, comprising in combination:
determining that there remote control commands for “record” and “play” are directed to the television receiver device;
checking a remote control receiver for receipt of either “record” or “play” command;
when a record command is received by the remote control receiver, storing N seconds of scaled video to a memory residing in the television receiver device; and
when a play command is received by the remote control receiver, playing out the N seconds of scaled video from the memory in a picture-in-picture (PIP) window.

20. The method according to claim 19, wherein upon receipt of the play command playing back the scaled video from the memory by opening the PIP window and causing the N seconds of scaled video to be multiplexed or overlaid on a main video signal.

21. The method according to claim 19, further comprising closing the PIP window after the playback of the N seconds of scaled video from the memory to the PIP window on the display.

22. The method according to claim 19, wherein N seconds is approximately equal to 5 to 10 seconds.

23. The method according to claim 19, wherein the playback is carried out in slow motion.

24. A computer readable storage medium storing instructions which, when executed on one or more programmed processors, carry out a method according to claim 19.
